(19) United States
(12) Patent Application Publication
(10) Pub. No.: US 2025/0313218 A1
(43) Pub. Date: Oct. 9, 2025

(54) VEHICLE COCKPIT LINKAGE METHODS, EQUIPMENT, MEDIA AND COMPUTER PROGRAM PRODUCTS

(71) Applicant: CARIAD (CHINA) CO., LTD., Beijing (CN)

(72) Inventors: Xi XIA, Beijing (CN); Wukun YI, Beijing (CN); Yang LIU, Beijing (CN); Ning DUAN, Beijing (CN)

(21) Appl. No.: 19/169,723

(22) Filed: Apr. 3, 2025

(30) Foreign Application Priority Data
Apr. 3, 2024 (CN) 202410405228.2

(51) Int. Cl. B60W 50/00; A63F 13/63; A63F 13/803; B60K 35/10; B60Q 3/70; B60Q 3/80

(52) U.S. Cl. CPC B60W 50/0098; A63F 13/63; A63F 13/803; B60K 35/10; B60Q 3/70; B60Q 3/80; B60K 2360/573; B60W 2050/0083

(57) ABSTRACT

The present disclosure relates to a method for vehicle cockpit coordinated control, a device, a medium, and a computer program product. The method comprises: acquiring user interaction for an application screen displayed within the vehicle cockpit; and triggering the vehicle cockpit coordinated control on the basis of the application screen and the user interaction.

### TECHNICAL FIELD

The present disclosure generally relates to the field of vehicle control, and more particularly, to a method for vehicle cockpit coordinated control, a device, a medium, and a computer program product.

### BACKGROUND

With the continuous development of science and technology, automobiles are no longer merely transportation vehicles, but have gradually become mobile smart spaces. The widespread adoption of in-vehicle systems and smart mobile devices within a vehicle cockpit has brought enhanced convenience and comfort for users. Therefore, in addition to providing basic driving information and entertainment functions, modern in-vehicle technologies are also evolving toward greater intelligence and personalization.

With the widespread adoption of smart mobile devices and the continuous upgrading of in-vehicle systems, users have become accustomed to operating various applications within the vehicle cockpit using smart devices such as mobile phones, tablet computers, and the like, ranging from navigation to music, video, gaming, etc. With the advancement of technology, the vehicle cockpit environment can also achieve coordinated control on the basis of user operations on the applications, thereby providing the users with a more personalized and comfortable driving environment and improving user experience.

### SUMMARY

In a first aspect of embodiments of the present disclosure, there is provided a method for vehicle cockpit coordinated control. The method comprises: acquiring user interaction for an application screen displayed within the vehicle cockpit; and triggering the vehicle cockpit coordinated control on the basis of the application screen and the user interaction.

In a second aspect of the embodiments of the present disclosure, there is provided an electronic device. The electronic device comprises one or more processors and a memory coupled to the at least one processor and having instructions stored thereon, the instructions, when executed by the at least one processor, causing the electronic device to execute actions comprising: acquiring user interaction for an application screen displayed within the vehicle cockpit; and triggering the vehicle cockpit coordinated control on the basis of the application screen and the user interaction.

In a third aspect of the embodiments of the present disclosure, there is provided a computer-readable storage medium on which a computer program is stored, the computer program, when executed by a processor, implementing the method for vehicle cockpit coordinated control. The method comprises: acquiring user interaction for an application screen displayed within the vehicle cockpit; and triggering the vehicle cockpit coordinated control on the basis of the application screen and the user interaction.

In a fourth aspect of the embodiments of the present disclosure, there is provided a computer program product. The computer program product is tangibly stored on a non-volatile computer-readable medium and comprises machine-executable instructions that, when executed, cause a machine to implement the method for vehicle cockpit coordinated control. The method comprises: acquiring user interaction for an application screen displayed within the vehicle cockpit; and triggering the vehicle cockpit coordinated control on the basis of the application screen and the user interaction.

It is to be understood that what is described in the Summary is not intended to limit key or important features of the embodiments of the present disclosure, nor is it intended to limit the scope of the present disclosure. Other features of the present disclosure are readily understood from the following description.

### BRIEF DESCRIPTION OF THE DRAWINGS

The features, advantages, and aspects of embodiments of the present disclosure, comprising those described above and others, are becoming more apparent when taken and with reference to the drawings and the following detailed description. In the drawings, the same or similar reference numerals indicate the same or similar elements, wherein:

FIG. 1 shows a schematic diagram of an example environment in which a plurality of embodiments of the present disclosure may be implemented;

FIG. 2 shows a flowchart of a method for vehicle cockpit coordinated control according to some embodiments of the present disclosure;

FIGS. 3A and 3B show schematic diagrams of examples of identifying character selection scenarios using a generic template and a specialized template according to some embodiments of the present disclosure;

FIG. 4 shows a schematic diagram of an example process of acquiring an object contour according to some embodiments of the present disclosure;

FIG. 5 shows a schematic diagram of an example process of extracting a color feature of an object contour according to some embodiments of the present disclosure;

FIG. 6 shows a schematic diagram of an example process of adjusting a vehicle cockpit environment by identifying a character corresponding to an object contour according to some embodiments of the present disclosure;

FIG. 7 shows a schematic diagram of an example process of achieving coordinated control with a vehicle cockpit on the basis of user interaction on a user mobile device according to some embodiments of the present disclosure;

FIG. 8 shows a schematic diagram of an apparatus for vehicle cockpit coordinated control according to some embodiments of the present disclosure; and

FIG. 9 shows a block diagram of a device that may implement a plurality of embodiments of the present disclosure.

### DETAILED DESCRIPTION OF THE EMBODIMENTS

Embodiments of the present disclosure are described in more detail below with reference to the drawings. While certain embodiments of the present disclosure are shown in the drawings, it is to be understood that the present disclosure may be implemented in various forms and is not to be construed as being limited to the embodiments set forth herein. Rather, these embodiments are provided to facilitate a more thorough and complete understanding of the present disclosure. It is to be understood that the drawings and embodiments of the present disclosure are solely for illustrative purposes and are not intended to limit the scope of protection of the present disclosure.

In the description of the embodiments of the present disclosure, the term “comprise” and similar terms are to be understood as open inclusion, that is, “include, but is not limited to”. The term “on the basis of” is to be understood as “at least in part on the basis of”. The term “one embodiment” or “the embodiment” is to be understood as “at least one embodiment”. The terms “first”, “second”, and the like may refer to different or the same objects. Other explicit and implicit definitions may also be comprised below.

As mentioned above, a vehicle cockpit has gradually evolved into a mobile multimedia entertainment space, in which a driver and passengers can operate various applications such as navigation, music, video, games, etc. through an in-vehicle system or a user mobile device to satisfy different user requirements. Some vehicle cockpits are equipped with lighting systems for creating an atmosphere, such as ambient lighting with adjustable color and brightness. The control authority of ambient lighting is usually managed by the in-vehicle system, which can issue control instructions to adjust the color, brightness, and other parameters of the ambient lighting according to a preset mode or data signals received in real time. In addition, some vehicles are also equipped with fragrance systems capable of emitting different fragrances within the cockpit to create different atmospheric experiences. The in-vehicle system can control the release timing and intensity of the fragrance. Moreover, the in-vehicle system may also issue control instructions to systems that are capable of engaging in sensory interaction with a user, such as an audio system, a seat massage system, an air conditioning system, or the like, of a vehicle, to change the operating states thereof. By centrally controlling these environmental hardware systems, the in-vehicle system can adjust the cockpit environment according to the received external data to provide the user with an immersive experience.

However, the interaction data between the user and the application is usually owned and managed by an application provider. To enable the coordinated control of the vehicle cockpit environment, in some related technologies, the application provider can provide relevant data interfaces to an in-vehicle system provider, so as to acquire real-time status data of the application currently being operated by the user. Such data may comprise, for example, an identifier, type, current scenario, interface element, and the like of the application. However, developing such data interfaces requires considerable time and resources, thereby resulting in high costs for the in-vehicle system provider. In other related technologies, an artificial intelligence-based object detection technology can be utilized to perform object detection on a single frame, thereby identifying objects within the application that the user is interacting with. However, artificial intelligence models may not be deployable when the computing resources of the in-vehicle system are limited. In addition, the inference process of artificial intelligence models may result in problems of latency, delayed responses, and the like. Moreover, different artificial intelligence models need to be trained for different applications, and a large amount of training data is required, resulting in high costs for obtaining trained models.

To this end, the embodiments of the present disclosure provide a vehicle cockpit coordinated control solution capable of acquiring an application screen displayed within the vehicle cockpit and user interaction for the application screen, and triggering the vehicle cockpit coordinated control on the basis of the application screen and the user interaction. In this way, the scenario of the application and the interactive object can be determined on the basis of the application screen and the user interaction, without invoking the data interfaces from the application provider. Therefore, this enables the in-vehicle system provider to independently implement vehicle cockpit coordinated control, thereby reducing costs. In addition, compared with solutions that use artificial intelligence-based object detection technologies, this solution uses user interaction data to assist in determining interactive objects on the screen, thereby improving processing speed, reducing response time, enhancing versatility, and reducing the costs consumed for training the artificial intelligence models.

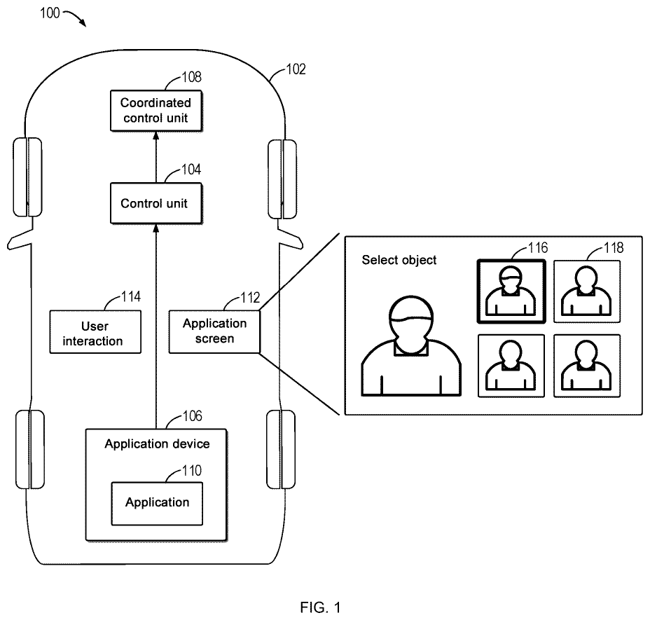

FIG. 1 shows a schematic diagram of an example environment 100 in which a plurality of embodiments of the present disclosure may be implemented. As shown in FIG. 1, the environment 100 comprises a vehicle 102 which comprises a control unit 104, an application device 106, and a coordinated control unit 108. The control unit 104 may be any device with computing or processing capabilities. For example, the control unit 104 may be an in-vehicle system, a desktop computer, a laptop computer, a tablet computer, a server, a mobile device, a control unit of a vehicle (comprising a vehicle control unit and a subsystem control unit), or the like. The control unit 104 may issue control instructions to the coordinated control unit 108 to change the state of the coordinated control unit 108.

The application device 106 is a device configured to run the application 110. For example, the application device 106 may be a personal mobile device of the user (e.g., a mobile phone, a tablet computer, etc.). The application 110 may be any application running on the user mobile device (e.g., a game application, a music application, a video application, a navigation application, etc.). In some embodiments of the present disclosure, the application device 106 may be the same assembly as the control unit 104. For example, the control unit 104 and the application device 106 may both refer to an in-vehicle system of the vehicle 102. In these embodiments, the application 110 may be any application running on the in-vehicle system, such as a game application, a music application, a video application, a navigation application, or the like.

The coordinated control unit 108 is any assembly within the cockpit of the vehicle 102 that is capable of engaging in sensory interaction with the user. For example, the coordinated control unit 108 may comprise ambient lighting, audio, an air conditioner, seats, fragrance, and the like within the cockpit. For example, the ambient lighting may respond to user operations on the application 110 by changing color, adjusting brightness, flashing, or the like; the audio may respond to the user operations on the application 110 by adjusting the volume, playing specific sounds, or the like; and the air conditioner may respond to the user operations on the application 110 by changing the airflow intensity, or the like.

As shown in FIG. 1, in the environment 100, the user may operate the application 110 through the application device 106. More specifically, the user may perform the user interaction 114 for the application screen 112 in the application screen 112. The application screen 112 may comprise a plurality of objects, for example, an object 116, an object 118, and the like. The user interaction 114 may be a click or touch on the application screen 112. Furthermore, the object 116 may be selected because the location of the click or touch falls within a region associated with the object 116.

In some related technologies, the control unit 104 may acquire, from an interface provided by a provider of the application 110, an identifier of a scenario of the application screen 112, a description of the scenario of the application screen 112, an identifier of an object selected by the user, and a description of the object selected by the user. In other related techniques, the control unit 104 may identify the scenario of the application screen 112 and the object selected by the user solely on the basis of the application screen 112 and by utilizing the artificial intelligence-based object detection technology. However, the approach of invoking interfaces requires high costs, while the artificial intelligence-based approach not only requires a large amount of training data to train models for different applications, but also introduces latency in the inference stage of the models, thereby deteriorating user experience.

In the embodiments according to the present disclosure, the control unit 104 may acquire the application screen 112 and the user interaction 114 from the application device 106. For example, the in-vehicle system may capture the application screen 112 and the associated user interaction 114 of the application 110 running thereon, or another application (e.g., a screen-projection application) on the application device 106 may acquire the application screen 112 and the user interaction 114 before transmitting to the control unit 104. Therefore, on the basis of the application screen 112 and the user interaction 114, information such as a scenario of the application screen 112, a region clicked or touched by the user interaction 114, whether a valid object is selected in the region, features of the selected object, and the like can be analyzed. Then, the control unit 104 can issue corresponding control instructions to the coordinated control unit 108 on the basis of the information, thereby implementing vehicle cockpit coordinated control. In this way, vehicle cockpit coordinated control can be implemented without using data interfaces from application providers and artificial intelligence-based object detection technologies, thereby reducing costs, reducing latency, enhancing versatility, and improving user experience.

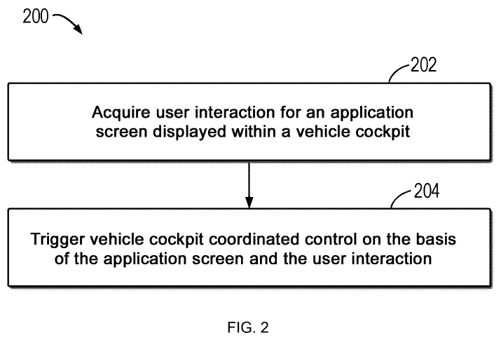

FIG. 2 shows a flowchart of a method 200 for vehicle cockpit coordinated control according to some embodiments of the present disclosure. The method 200 may, for example, be performed by the control unit 104 in the environment 100 shown in FIG. 1. As shown in FIG. 2, at block 202, the method 200 may acquire user interaction for an application screen displayed within the vehicle cockpit. For example, in the environment 100 shown in FIG. 1, the control unit 104 may acquire the application screen 112 and the user interaction 114 for the application screen 112. For example, when the control unit 104 and the application device 106 are two separate assemblies (e.g., the control unit 104 is an in-vehicle system and the application device 106 is a user mobile device), the control unit 104 may acquire the application screen 112 and the user interaction 114 from the application device 106 (e.g., via a screen-projection application on the application device 106). When the control unit 104 and the application device 106 are the same assembly (e.g., both are in-vehicle systems), the control unit 104 may directly acquire the application screen 112 and the user interaction 114 of the application 110 running thereon.

At block 204, the method 200 may trigger the vehicle cockpit coordinated control on the basis of the application screen and the user interaction. For example, in the environment 100 shown in FIG. 1, the control unit 104 can analyze, on the basis of the application screen 112 and the user interaction 114, information such as a scenario of the application screen 112, a region clicked or touched by the user interaction 114, whether a valid object is selected in the region, features of the selected object, and the like. Then, the control unit 104 can issue corresponding control instructions to the coordinated control unit 108 on the basis of the information, thereby implementing vehicle cockpit coordinated control. The vehicle cockpit coordinated control may comprise, for example, adjusting the color and brightness of the ambient lighting in response to the user interaction 114, causing the ambient lighting to flash, adjusting the volume of the audio, causing the audio to play back a specific sound effect, turning on the air conditioner, changing the airflow intensity of the air conditioner, causing the seat to vibrate, changing the type and intensity of the fragrance, and the like.

In this way, the scenario of the application and the interactive object can be determined on the basis of the application screen and the user interaction, without invoking the data interfaces from the application provider. Therefore, this enables the in-vehicle system provider to independently implement vehicle cockpit coordinated control, thereby reducing costs. In addition, compared with solutions that use artificial intelligence-based object detection technologies, user interaction data may be used to assist in determining interactive objects on the screen, thereby improving processing speed, reducing response time, enhancing versatility, and reducing the costs consumed for training the artificial intelligence models.

The solution according to the present disclosure may be applied to any type of application and to any suitable scenario within the application. For example, the solution according to the present disclosure may be applied to a character selection scenario or a map selection scenario in a game application, a playlist selection scenario or a favorite music type selection scenario in a music application, a restaurant selection scenario in a lifestyle service application, and the like. The solution according to the present disclosure is particularly suitable for the character selection scenario in the game application, in which the user's attention has not yet been completely focused on the game process. In this case, the coordinated control of the vehicle cockpit can allow the user to quickly immerse in the game atmosphere, thereby improving user experience more effectively. Therefore, other embodiments of the present disclosure are described below by taking the character selection scenario in the game application as an example.

In some embodiments, in order to trigger vehicle cockpit coordinated control on the basis of the application screen and the user interaction, it may be determined whether the application screen matches a target scenario. Then, in response to the application screen matching the target scenario, the vehicle cockpit coordinated control may be triggered on the basis of the application screen and the user interaction. In some embodiments, in order to determine whether the application screen matches the target scenario, a template for the target scenario may be acquired, and the template comprises a target feature corresponding to the target scenario. Then, when it is determined that the application screen has a feature corresponding to the target feature, it may be determined that the application screen matches the target scenario.

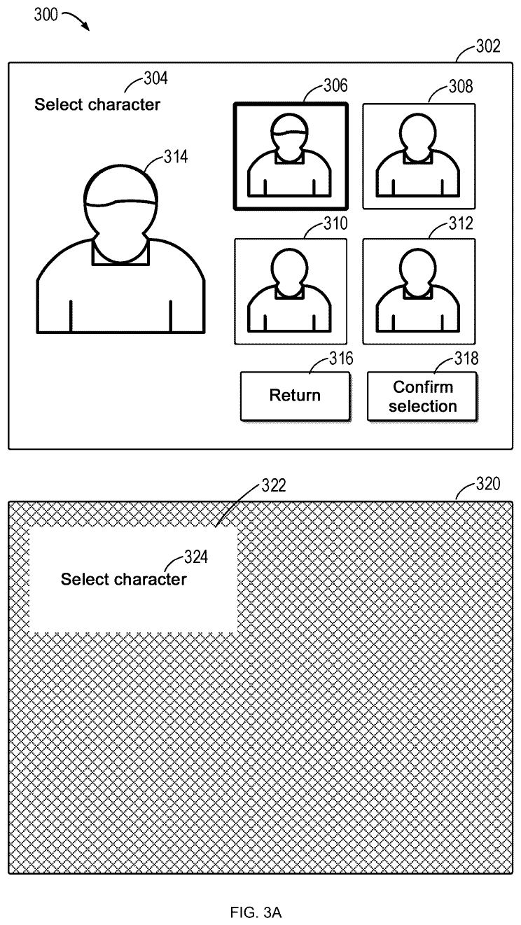

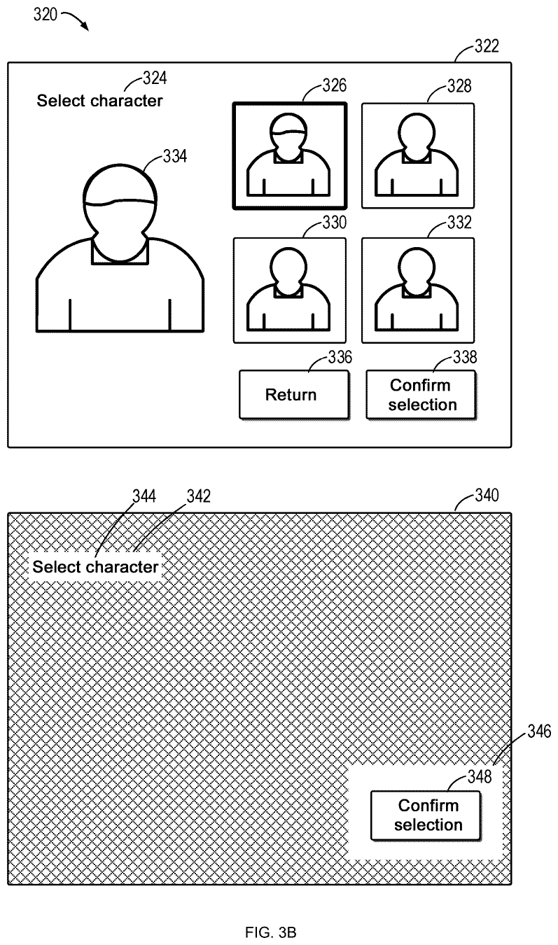

FIGS. 3A and 3B show schematic diagrams of examples of identifying character selection scenarios using a generic template and a specialized template according to some embodiments of the present disclosure. In some embodiments, in the absence of a specialized template for a target scenario of a specific application, a generic template for the target scenario may be used to determine whether the application screen matches the target scenario. FIG. 3A shows a schematic diagram of an example 300 of identifying a character selection scenario in a game application using a generic template according to some embodiments of the present disclosure. As shown in FIG. 3A, the example 300 comprises a game screen 302 in the game application. The game screen 302 comprises a character selection text 304, a character 306, a character 308, a character 310, a character 312, a character preview 314 of the character 306, a return button 316, and a confirm selection button 318.

As shown in FIG. 3A, the example 300 further comprises a generic template 320 which is configured to determine whether the game screen 302 belongs to a character selection scenario. The generic template 320 comprises a region 322 and a target text 324 (i.e., “select character”). The generic template 320 may indicate that if the target text 324 appears in the region 322 of the game screen, it may be determined that the game screen belongs to the character selection scenario. In the example 300, a region in the game screen 302 corresponding to the region 322 in the generic template 320 may be acquired, and then it may be determined that the target text 324 is comprised in the region, thereby determining that the game screen 302 belongs to the character selection scenario. In some embodiments, instead of comparing an image in the region with an image in the region 322 of the generic template 320, the text content in the region may be acquired through image recognition and then compared with the target text 324. In this way, it can be accurately determined that the game screen 302 matches the generic template 320 even when the character selection text 304 has different fonts.

In this way, as long as the game screen 302 has the target feature indicated by the generic template 320 (that is, the target region 322 has the target text 324), it can be determined that the game screen 302 belongs to the character selection scenario without the need to identify other elements in the game screen 302 (e.g., the character 306, the character 308, the character 310, the character 312, the character preview 314, the return button 316, and the confirm selection button 318). In this way, the speed and versatility of target scenario identification can be enhanced.

For ease of understanding, the generic template 302 is shown in the form of an image in the example 300. However, the generic template 302 may also be stored in other data formats. For example, the target region 322 may be stored as coordinates of two opposite corners of a rectangular box, and the target text 324 may be stored as separate text.

In some embodiments, the control unit may acquire an identifier of the running application, and then read a pre-stored specialized template for the application on the basis of the identifier, and determine whether the application screen matches the target scenario on the basis of the specialized template. FIG. 3B shows a schematic diagram of an example 320 of identifying a character selection scenario in a game application using a specialized template according to some embodiments of the present disclosure. As shown in FIG. 3B, the example 320 comprises a game screen 322. The game screen 322 comprises a character selection text 324, a character 326, a character 328, a character 330, a character 332, a character preview 334 of the character 326, a return button 336, and a confirm selection button 338.

As shown in FIG. 3B, the example 320 further comprises a specialized template 340 which is configured to determine whether the game screen 322 belongs to a character selection scenario of a particular game. The specialized template 340 comprises a region 342, a target text 344 (i.e., “select character”) corresponding to the region 342, a region 346, and a target object 348 (i.e., a confirm selection button) corresponding to the region 346. The specialized template 340 may indicate that the game screen is determined to belong to the character selection scenario if the target text 344 appears in the region 342 of the game screen (or at a specific position) and the target object 348 appears in the region 346 (or at another specific position). In the example 320, a region in the game screen 322 corresponding to the region 342 in the specialized template 340 may be acquired, and then it is determined that the target text 344 is comprised in the region. Furthermore, a region in the game screen 322 corresponding to the region 346 in the specialized template 340 may be acquired, and then it is determined that the target object 348 is comprised in the region. Therefore, it may be determined that the game screen 322 belongs to the character selection scenario.

Since the specialized template 340 is specifically generated for the currently running game, the specialized template 340 may comprise more target features than the generic template, which means stricter matching conditions. This allows for more accurate identification of whether the game screen belongs to the character selection scenario and reduction of mistakenly identifying a non-character selection scenario screen as the character selection scenario. Using templates to determine whether the application screen matches the target scenario can improve the processing efficiency of the process, thereby reducing latency and improving user experience.

In some embodiments, in order to trigger the vehicle cockpit coordinated control on the basis of the application screen and the user interaction, a region of interest associated with the user interaction may be determined on the basis of the application screen and the user interaction, then an object contour within the region of interest may be determined, and the vehicle cockpit coordinated control is triggered on the basis of the object contour. In some embodiments, in order to determine the region of interest associated with the user interaction, coordinates associated with the user interaction in the application screen may be acquired, and then the region of interest in the application screen may be determined on the basis of the coordinates. In some embodiments, in order to trigger the vehicle cockpit coordinated control, a color feature of the object contour may be determined, and then the vehicle ambient lighting may be adjusted on the basis of the color feature of the object contour.

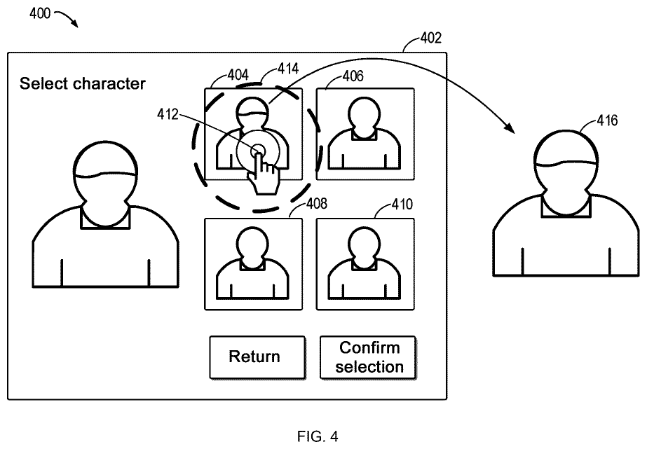

FIG. 4 shows a schematic diagram of an example process 400 of acquiring an object contour according to some embodiments of the present disclosure. As shown in FIG. 4, the game screen 402 is a game screen in the character selection scenario and comprises a character 404, a character 406, a character 408, and a character 410. In the example process 400, the user clicks on a region where the character 404 is located, and then the process 400 may determine coordinates 412 of a touch event corresponding to the click (i.e., user interaction), and determine a region of interest 414 on the basis of the coordinates 412. For example, the region of interest 414 may be a circular region with the coordinates 412 of the touch event as a center and a predefined specific value as a radius. In addition, the region of interest 414 may be a square region with the coordinates 412 of the touch event as a center and a predefined specific value as a side length.

After the region of interest 414 is determined, contour segmentation may be performed on the region of interest 414 to obtain an object contour 416 within the region of interest 414. Since the object contour 416 corresponds to the character 404, vehicle cockpit coordinated control may be triggered on the basis of the object contour 416 to achieve an effect that the vehicle cockpit environment changes accordingly when the user selects the object 414. For example, the process 400 may perform grayscale processing on the region of interest 414 to obtain a grayscaled region of interest 414. Then, the process 400 may perform an edge detection algorithm on the grayscaled region of interest 414 to generate a binarized edge image comprising edge information for the region of interest 414, in which edge pixels may be labeled in white and non-edge pixels may be labeled in black. Then, the process 400 may apply a contour segmentation algorithm to the binarized edge image to generate the object contour 416 in the image.

After the object contour 416 is generated, the process 400 may determine a color feature of the object contour 416, and then adjust the vehicle ambient lighting on the basis of the color feature of the object contour 416. In some embodiments, the color feature may comprise at least one of a dominant hue, a color band proportion, or a brightness proportion. In some embodiments, the process 400 may determine a dominant hue of the image within the object contour 416 and adjust the color of the ambient lighting on the basis of the dominant hue. For example, if the dominant hue within the object contour 416 is blue, the vehicle ambient lighting may be adjusted to blue accordingly. In some embodiments, the vehicle cockpit may support the simultaneous activation of ambient lighting of different colors, and the process 400 may determine the color band proportion within the object contour 416 and adjust the ambient lighting on the basis of the color band proportion. For example, if the proportions of blue and red are the highest within the object contour 416, the blue and red ambient lighting may be activated simultaneously. In some embodiments, the process 400 may determine the brightness proportion of each color band within the object contour 416, and then adjust the color and brightness of the ambient lighting on the basis of the brightness proportion. For example, if the proportions of blue and red are the highest within the object contour 416, and red is brighter than blue, the blue and red ambient lighting may be activated simultaneously, while setting red to be brighter and setting blue to be darker.

In some embodiments, after the color band proportion within the object contour 416 is determined, the color band proportion may be compared with predefined color band proportions of respective characters. If the color band proportion within the object contour 416 matches the color band proportion of a certain character, the color of the ambient lighting may be adjusted on the basis of the color scheme of this character.

In this way, the object selected by the user can be determined on the basis of the coordinates of the touch event of the user interaction and the application screen. Furthermore, the feature of the object can be determined through contour segmentation and extraction of a color feature of the contour, without using the artificial intelligence-based object detection technology, thereby adjusting the vehicle cockpit environment according to the feature of the object. In this way, the vehicle cockpit environment can be matched with the feature of the object selected by the user, thereby allowing the user to immerse more deeply in the atmosphere of the application.

In some embodiments, in order to to determine the color feature of the object contour, a plurality of color bands displayable by the vehicle ambient lighting may be determined, and pixels within the object contour may be clustered into a plurality of pixel sets on the basis of the plurality of color bands. Then, the color feature of the object contour may be determined on the basis of the number of pixels in the plurality of pixel sets.

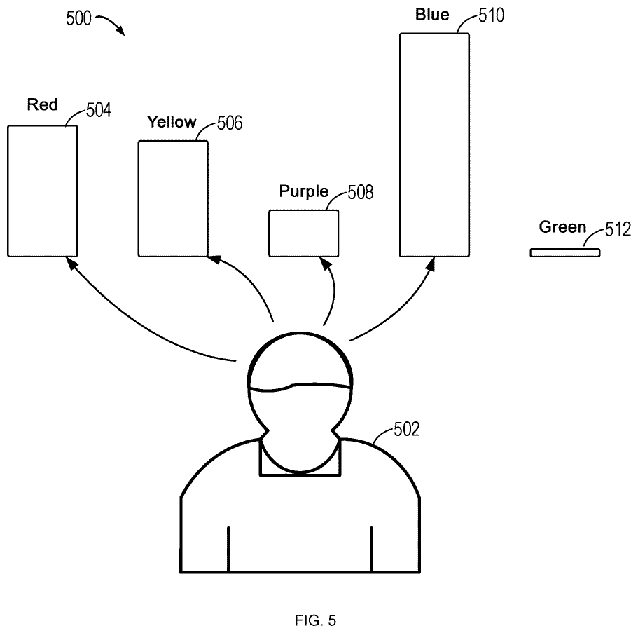

FIG. 5 shows a schematic diagram of an example process 500 of extracting a color feature of an object contour according to some embodiments of the present disclosure. As shown in FIG. 5, the process 500 may determine all color bands displayable by the vehicle ambient lighting, and then determine a plurality of target color bands from all the color bands, which may, for example, be color bands with significant color differences. For example, the vehicle can support 20 color bands, and 5 color bands with significant differences may be selected from the 20 color bands, such as red, yellow, purple, blue, and green as shown in FIG. 5. Then, the process 500 may cluster the pixels in the object contour 502 into 5 pixel sets according to color, i.e., a pixel set 504 corresponding to red, a pixel set 506 corresponding to yellow, a pixel set 508 corresponding to purple, a pixel set 510 corresponding to blue, and a pixel set 512 corresponding to green. During the clustering process, the process 500 may calculate the distance between the color of the pixel to be clustered and each of the 5 color centers, with values representing red, yellow, purple, blue, and green as the center. If the minimum value of the 5 calculated distances is less than a predetermined threshold, it indicates that the color of the pixel is closest to the color corresponding to the center value, and the pixel can be clustered into the corresponding set. If none of the minimum values of the 5 calculated distances is less than the predetermined threshold, it indicates that none of the 5 colors is close to the pixel, and the pixel is not clustered into any of the 5 sets.

In the example shown in FIG. 5, pixels close to red (e.g., comprising light red or dark red, etc.) within the object contour 502 may be clustered into the set 504, pixels close to yellow may be clustered into the set 506, pixels close to purple may be clustered into the set 508, pixels close to blue may be clustered into the set 510, and pixels close to green may be clustered into the set 512 (in the example shown in FIG. 5, no pixels are close to green, so no pixels are clustered into the set 512). As shown in FIG. 5, the set 510 has the largest number of pixels, followed by the set 514, the set 516, and the set 518. In some embodiments, blue corresponding to the set 510 may be used as the dominant hue to illuminate the blue color band of the ambient lighting. In some embodiments, a plurality of color bands of the ambient lighting, such as blue, red, and yellow, may be illuminated on the basis of the color band proportion.

In this way, a color feature can be extracted from the object contour, and the color of the ambient lighting of the vehicle cockpit can be adjusted on the basis of the color feature. This process requires less amount of computation, and therefore can achieve a balance between computation speed and implementation effect, while reducing latency caused by computation and allowing the user to immerse in the target scenario, thereby improving user experience.

In some embodiments, a similar method may be employed to determine whether user interaction selects an object in an application. In these embodiments, all color bands displayable by the vehicle ambient lighting may be determined, then a plurality of target color bands may be determined from all the color bands, and white and black may be additionally added to the plurality of target color bands. Then, pixels in the object contour may be clustered into a plurality of pixel sets corresponding to the plurality of target color bands (comprising white and black), and whether the user interaction is the target interaction is determined on the basis of the number of pixels in the plurality of pixel sets. For example, the target interaction may be selecting an object. If the user interaction does not select the object but instead clicks on an invalid background region, the user interaction is not the target interaction. Since the background color of most of the application screens is close to white or black, if the number of pixels of the pixel set corresponding to white exceeds a predetermined proportion, or if the number of pixels of the pixel set corresponding to black exceeds a predetermined proportion, it may be determined that the user interaction clicks in the invalid background region rather than a valid object region. In the case where the user interaction is the target interaction, the color of the ambient lighting of the vehicle cockpit may be adjusted according to the dominant hue, the color band proportion, or the brightness proportion.

In this way, erroneous triggering of vehicle cockpit coordinated control when the user interaction is not the target interaction can be reduced, and the calculation process can be terminated in advance, thereby saving computing resources and improving user experience.

In some embodiments, in order to trigger vehicle cockpit coordinated control on the basis of the object contour, a predetermined target contour of a target object may be acquired. Then, the presence of the target object within the region of interest may be determined on the basis of the object contour and the target contour. Then, the vehicle cockpit coordinated control may be triggered on the basis of the predetermined configuration information corresponding to the target object. In some embodiments, to trigger vehicle cockpit coordinated control, at least one of vehicle ambient lighting, in order in-cockpit lighting, vehicle audio, seats, air conditioner, or fragrance may be adjusted on the basis of the predetermined configuration information corresponding to the target object.

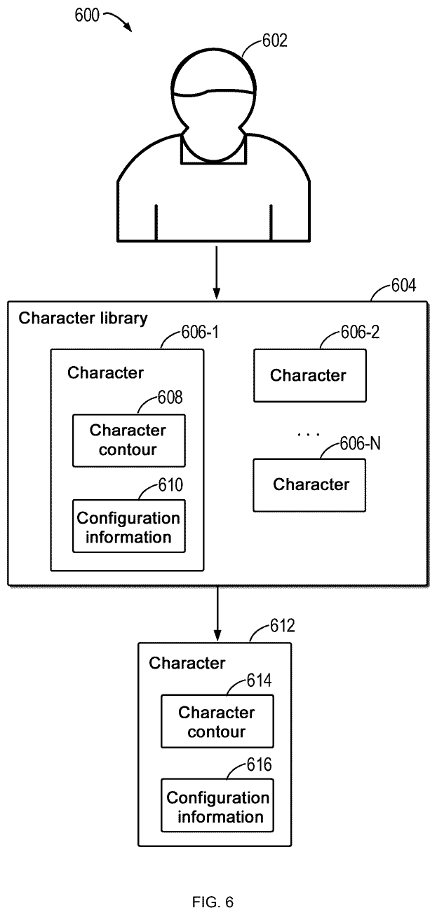

FIG. 6 shows a schematic diagram of an example process 600 of adjusting a vehicle cockpit environment by identifying a character corresponding to an object contour according to some embodiments of the present disclosure. As shown in FIG. 6, the process 600 may determine a region of interest on the basis of the game screen and the coordinates of the user interaction, and then obtain an object contour 602 from the region of interest through contour segmentation. Before determining the color feature of the object contour 602, the object contour 602 may be compared with characters 606-1, 606-02, . . . , and 606-N (collectively referred to as characters 606) that are pre-stored in a character library 604. Each character 606 comprises a character contour and configuration information for the character. For example, the character 606-1 comprises a character contour 608 and configuration information 610. The process 600 may match the object contour 602 to the character contour of each character 606.

In the example shown in FIG. 6, the object contour 602 matches a character contour 614 of a character 612 in the character library 604, and thus it can be determined that the user interaction selects the character 612, and the vehicle cockpit coordinated control can be triggered on the basis of the configuration information 616 of the character 612. The configuration information 616 may comprise, for example, a dominant hue, a color band proportion, and a brightness proportion of ambient lighting for the character 612, as well as a sound effect, a seat vibration intensity, air conditioner airflow intensity, fragrance type, and the like. In this way, the interactive form of the cockpit environment can be enriched, and the vehicle cockpit coordinated control can be triggered for a specific character on the basis of predetermined configuration information, making the cockpit environment more in harmony with the character, thereby allowing the user to better immerse in the game.

As described above, the game application (or other application) may be installed in an in-vehicle system, so that the in-vehicle system can easily acquire the game screen and user interaction of the game application running thereon. However, compared with game applications on the in-vehicle system, game applications on a personal mobile device of the user are often more diverse, and in some scenarios, the user tends to use the personal mobile device rather than the in-vehicle system to play games. In this case, the in-vehicle system needs to acquire the game screen and the user interaction from the user mobile device.

In some embodiments, the application currently being operated by the user and installed on the user mobile device is a first application. To acquire the user interaction for the application screen displayed in the vehicle cockpit, the user interaction for the application screen may be acquired from a second application installed on the user mobile device and associated with the vehicle, wherein the application screen and the user interaction originate from the first application.

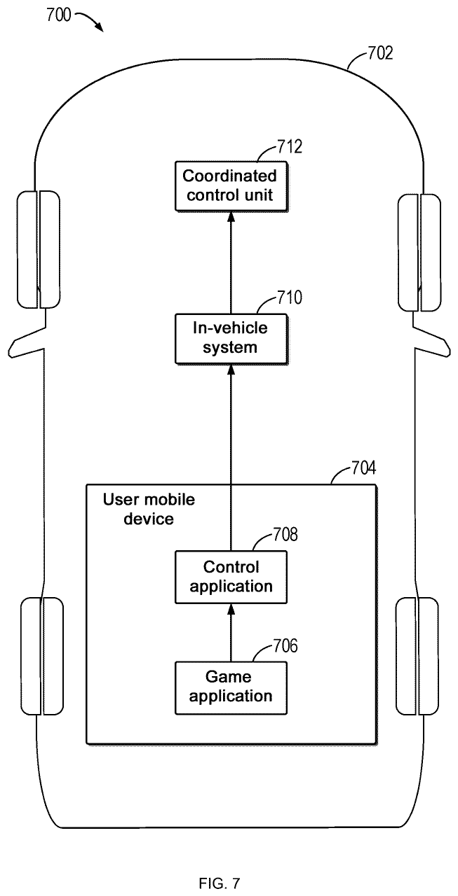

FIG. 7 shows a schematic diagram of an example process 700 of achieving coordinated control with a vehicle cockpit on the basis of user interaction on a user mobile device according to some embodiments of the present disclosure. As shown in FIG. 7, the user may operate a game application 706 in a vehicle 702 using a user mobile device 704 which may be a mobile device such as a mobile phone, a tablet computer, or the like. The game application 706 may be a game application from any game provider and runnable on the user mobile device 704. Also installed on the user mobile device 704 is a control application 708 which is an application capable of acquiring a game screen and user interaction from the game application 706, and communicating with the in-vehicle system 710 to transmit the game screen and the user interaction acquired from the game application 706 to the in-vehicle system 710. For example, the control application 708 may be a screen-projection application, and the user may transmit the game screen and the user interaction to the in-vehicle system 710 via a screen-projection function or a screen mirroring function. The control application 708 may also be a communication application that transmits the game screen and the user interaction to the in-vehicle system 710 without requiring screen casting.

In this way, after acquiring the game screen and the user interaction from the control application 708, the in-vehicle system 710 may analyze the game screen and the user interaction and issue control instructions to a coordinated control unit 712 to adjust the cockpit environment of the vehicle 702. The coordinated control unit 712 may comprise, for example, ambient lighting, audio, an air conditioner, seats, fragrance, and the like within the cockpit. In this way, when the user operates the game application on the personal mobile device (e.g., selects a certain character on a character selection screen), the vehicle cockpit coordinated control can also be triggered, rather than being limited solely to gaming operations on the in-vehicle system, thereby enhancing the versatility of the cockpit coordinated control.

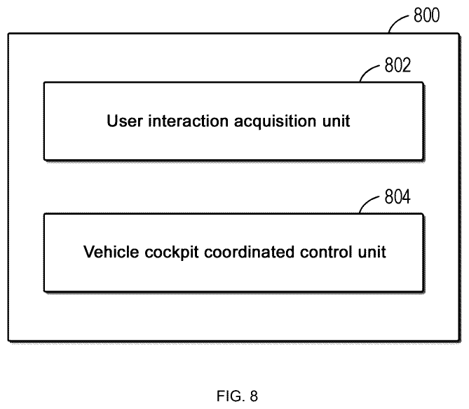

FIG. 8 shows a block diagram of an apparatus 800 for vehicle cockpit coordinated control according to some embodiments of the present disclosure. As shown in FIG. 8, the apparatus 800 comprises a user interaction acquisition unit 802 configured to acquire user interaction for an application screen displayed within the vehicle cockpit. The apparatus 800 further comprises a vehicle cockpit coordinated control unit 804 configured to trigger the vehicle cockpit coordinated control on the basis of the application screen and the user interaction. It is to be understood that, by employing the apparatus 800 of the present disclosure, at least one of many advantages achievable by the methods or processes described above may be achieved. For example, vehicle cockpit coordinated control can be implemented without using data interfaces from application providers and artificial intelligence-based object detection technologies, thereby reducing costs, reducing latency, enhancing versatility, and improving user experience.

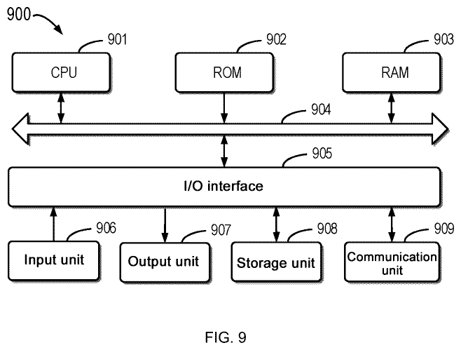

FIG. 9 shows a schematic block diagram of an example device 900 that may be used to implement embodiments of the present disclosure. For example, the control unit 104 in FIG. 1 may be the example device 900 as shown in FIG. 9. As shown, the device 900 comprises a computing unit 901 which can execute various appropriate actions and processes according to computer program instructions stored in a read-only memory (ROM) 902 or loaded from a storage unit 908 into a random-access memory (RAM) 903. In the RAM 903, various programs and data required for the operation of the device 900 may also be stored. The computing unit 901, the ROM 902, and the RAM 903 are mutually connected via a bus 904. An input/output (I/O) interface 905 is also connected to the bus 904.

A plurality of components in the device 900 are connected to the I/O interface 905, comprising: an input unit 906, such as a keyboard, a mouse, and the like; an output unit 907, such as various types of displays, speakers, and the like; a storage unit 908, such as a magnetic disk, an optical disc, and the like; and a communication unit 909, such as a network card, a modem, a wireless communication transceiver, and the like. The communication unit 909 allows the device 900 to exchange information/data with other devices via a computer network such as the Internet and/or various telecommunication networks.

The computing unit 901 may be various general-purpose and/or dedicated processing components having processing and computing capabilities. Some examples of the computing unit 901 include, but are not limited to, a central processing unit (CPU), a graphics processing unit (GPU), various dedicated artificial intelligence (AI) computation chips, various computing units running machine learning model algorithms, a digital signal processor (DSP), and any suitable processor, controller, microcontroller, etc. The computing unit 901 executes various methods and processes described above, such as the method 200. For example, in some embodiments, the method 200 may be implemented as a computer software program which is tangibly comprised in a machine-readable medium, such as the storage unit 908. In some embodiments, part or all of the computer program may be loaded and/or installed onto the device 900 via the ROM 902 and/or the communication unit 909. When the computer program is loaded into the RAM 903 and executed by the computing unit 901, one or more steps of the method 200 described above may be performed. Alternatively, in other embodiments, the computing unit 901 may be configured to perform the method 200 by any other suitable means (e.g., via firmware).

The functions described above herein may be performed at least partially by one or more hardware logic components. For example, without limitation, exemplary types of hardware logic components that can be used comprise: a field-programmable gate array (FPGA), an application-specific integrated circuit (ASIC), an application-specific standard product (ASSP), a system on a chip (SOC), a complex programmable logic device (CPLD), and the like.

The program code for implementing the methods of the present disclosure may be written in any combination of one or more programming languages. The program code may be provided to a processor or controller of a general-purpose computer, a dedicated computer, or other programmable data processing apparatus, so that when the program code is executed by the processor or controller, the functions/operations defined in the flowchart and/or block diagram are implemented. The program code may be executed entirely on a machine, partially on a machine, partially on a machine and partially on a remote machine as a standalone software package, or entirely on a remote machine or server.

In the context of the present disclosure, a machine-readable medium may be a tangible medium that can comprise or store a program for use by, or in conjunction with, an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of the machine-readable storage medium may comprise an electrical connection on the basis of one or more wires, a portable computer disk, a hard disk, a random-access memory (RAM), a read-only memory (ROM), an erasable programmable read-only memory (EPROM) or flash memory, an optical fiber, a portable compact disc read-only memory (CD-ROM), an optical storage device, a magnetic storage device, or any suitable combination of the foregoing. In addition, although the operations are depicted in a particular order, it is not to be understood as requiring that such operations be performed in the particular order shown or in sequential order, or that all illustrated operations are to be performed to achieve a desired result. Multitasking and parallel processing may be beneficial under certain circumstances. Likewise, although several specific implementation details are comprised in the discussion above, these are not to be construed as limiting the scope of the present disclosure. Certain features described in the context of separate embodiments may also be implemented in combination in a single implementation. Conversely, various features described in the context of a single implementation may also be implemented in a plurality of implementations individually or in any suitable sub-combination.

Although the subject matter has been described using language specific to structural features and/or methodological logical actions, it is to be understood that the subject matter defined in the appended claims is not necessarily limited to the specific features or actions described above. Conversely, the specific features and actions described above are merely example forms of implementing the claims.

1. A method for vehicle cockpit coordinated control, comprising:
acquiring user interaction for an application screen displayed within the vehicle cockpit; and
triggering the vehicle cockpit coordinated control on the basis of the application screen and the user interaction.

2. The method according to claim 1, wherein triggering the vehicle cockpit coordinated control on the basis of the application screen and the user interaction comprises:
determining whether the application screen matches a target scenario; and
triggering, in response to the application screen matching the target scenario, the vehicle cockpit coordinated control on the basis of the application screen and the user interaction.

3. The method according to claim 2, wherein determining whether the application screen matches a target scenario comprises:
acquiring a template for the target scenario, the template comprising a target feature corresponding to the target scenario; and
determining, when it is determined that the application screen has a feature corresponding to the target feature, that the application screen matches the target scenario.

4. The method according to claim 2, wherein triggering, in response to the application screen matching the target scenario, the vehicle cockpit coordinated control on the basis of the application screen and the user interaction comprises:
determining, on the basis of the application screen and the user interaction, a region of interest associated with the user interaction;
determining an object contour within the region of interest; and
triggering the vehicle cockpit coordinated control on the basis of the object contour.

5. The method according to claim 4, wherein determining, on the basis of the application screen and the user interaction, a region of interest associated with the user interaction comprises:
acquiring coordinates associated with the user interaction in the application screen; and
determining the region of interest in the application screen on the basis of the coordinates.

6. The method according to claim 4, wherein triggering the vehicle cockpit coordinated control on the basis of the object contour comprises:
determining a color feature of the object contour; and
adjusting vehicle ambient lighting on the basis of the color feature of the object contour.

7. The method according to claim 6, wherein determining a color feature of the object contour comprises:
determining a plurality of color bands displayable by the vehicle ambient lighting;
clustering pixels within the object contour into a plurality of pixel sets on the basis of the plurality of color bands; and
determining the color feature of the object contour on the basis of the number of pixels in the plurality of pixel sets.

8. The method according to claim 6, wherein the color feature comprises at least one of: a dominant hue, a color band proportion, or a brightness proportion.

9. The method according to claim 4, wherein triggering the vehicle cockpit coordinated control on the basis of the object contour comprises:
acquiring a predetermined target contour of a target object;
determining the presence of a target object within the region of interest on the basis of the object contour and the target contour; and
triggering the vehicle cockpit coordinated control on the basis of predetermined configuration information corresponding to the target object.

10. The method according to claim 9, wherein triggering the vehicle cockpit coordinated control on the basis of predetermined configuration information corresponding to the target object comprises:
adjusting, on the basis of the predetermined configuration information corresponding to the target object, at least one of: vehicle ambient lighting, in-cockpit lighting, vehicle audio, seats, air conditioner, or fragrance.

11. The method according to claim 1, wherein the application is a first application installed on a user mobile device, and acquiring the user interaction for the application screen displayed within the vehicle cockpit comprises:
acquiring the user interaction for the application screen from a second application installed on the user mobile device and associated with the vehicle, wherein the application screen and the user interaction originate from the first application.

12. The method according to claim 2, wherein the application is a game application and the target scenario is a game character selection scenario.

13. An electronic device, comprising:
at least one processor; and
a memory, coupled to the at least one processor and having instructions stored thereon, the instructions, when executed by the at least one processor, causing the electronic device to:
acquire user interaction for an application screen displayed within the vehicle cockpit; and
trigger the vehicle cockpit coordinated control on the basis of the application screen and the user interaction.

14-15. (canceled)

16. The electronic device according to claim 13, wherein the instructions causing the electronic device to trigger the vehicle cockpit coordinated control on the basis of the application screen and the user interaction comprise instructions causing the electronic device to:
determine whether the application screen matches a target scenario; and
trigger, in response to the application screen matching the target scenario, the vehicle cockpit coordinated control on the basis of the application screen and the user interaction.

17. The electronic device according to claim 13, wherein the instructions causing the electronic device to determine whether the application screen matches a target scenario comprise instructions causing the electronic device to:
acquire a template for the target scenario, the template comprising a target feature corresponding to the target scenario; and
determine, when it is determined that the application screen has a feature corresponding to the target feature, that the application screen matches the target scenario.

18. The electronic device according to claim 13, wherein the instructions causing the electronic device to trigger, in response to the application screen matching the target scenario, the vehicle cockpit coordinated control on the basis of the application screen and the user interaction comprise instructions causing the electronic device to:
determine, on the basis of the application screen and the user interaction, a region of interest associated with the user interaction;
determine an object contour within the region of interest; and
trigger the vehicle cockpit coordinated control on the basis of the object contour.

19. The electronic device according to claim 16, wherein the instructions causing the electronic device to determine, on the basis of the application screen and the user interaction, a region of interest associated with the user interaction comprise instructions causing the electronic device to:
acquire coordinates associated with the user interaction in the application screen; and
determine the region of interest in the application screen on the basis of the coordinates.

20. The electronic device according to claim 16, wherein the instructions causing the electronic device to trigger the vehicle cockpit coordinated control on the basis of the object contour comprise instructions causing the electronic device to:
determine a color feature of the object contour; and
adjust vehicle ambient lighting on the basis of the color feature of the object contour.

21. The electronic device according to claim 18, wherein the instructions causing the electronic device to determining a color feature of the object contour comprise instructions causing the electronic device to:
determine a plurality of color bands displayable by the vehicle ambient lighting;
cluster pixels within the object contour into a plurality of pixel sets on the basis of the plurality of color bands; and
determine the color feature of the object contour on the basis of the number of pixels in the plurality of pixel sets.

22. A computer program product tangibly stored on a non-volatile computer-readable medium and comprising machine-executable instructions, the instructions, when executed, causing a machine to:
acquire user interaction for an application screen displayed within the vehicle cockpit; and
trigger the vehicle cockpit coordinated control on the basis of the application screen and the user interaction.
